(19) United States
(12) Patent Application Publication
(10) Pub. No.: US 2008/0241698 A1
(43) Pub. Date: Oct. 2, 2008

(54) LITHIUM SECONDARY BATTERY AND ELECTRODE FOR USE IN LITHIUM SECONDARY BATTERY

(75) Inventor: Takashi KATOH, Sagamihara-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: OHARA INC., Sagamihara-shi (JP)

(21) Appl. No.: 11/931,491

(22) Filed: Oct. 31, 2007

(30) Foreign Application Priority Data
Oct. 31, 2006 (JP) 2006-297178

(51) Int. Cl. H01M 10/36

(52) U.S. Cl. 429/319; 429/304; 429/188

(57) ABSTRACT

A non-aqueous lithium secondary battery capable of maintaining high capacity even when preserved under a high temperature circumstance or put to charge/discharge repetitively, the battery having an electrode in which at least one of a positive electrode or a negative electrode contains less than 5 wt % of a lithium ion conductive inorganic solid electrolyte powder and using an ion conductive non-aqueous electrolyte, and an electrode for use in the lithium secondary battery using an ion conducting non-aqueous electrolyte containing less than 5 wt % of a lithium ion conductive inorganic solid electrolyte powder.

### BACKGROUND OF THE INVENTION

1. Field of the Invention

The present invention concerns a lithium secondary battery and an electrode for use in the lithium secondary battery.

2. Description of the Related Art

Along with size reduction of electronic equipments, a demand has been increased also in batteries as power sources for the development of a secondary battery reduced in the size and the weight, having a high energy density and capable of repetitive charge and discharge. As a secondary battery satisfying such a demand, a secondary battery using a non-aqueous electrolyte has been put to practical use. The battery has an energy density several times as high as the existent battery using the electrolyte of the aqueous solution. Examples of them include a non-aqueous electrolyte secondary battery using a lithium-cobalt composite oxide, a lithium nickel oxide or a lithium-manganese oxide for a positive electrode and using an alloy or a carbon material for a negative electrode of a non-aqueous electrolyte secondary battery. They are described, for example, in JP-A Nos. 10-116632, 2002-289176, and 2003-173769.

As described above, along with increase in the capacity, safety of the battery has caused significant problems. For example, in a case where a battery is put in a high temperature state, a non-aqueous electrolyte and an electrode active material take place a chemical reaction to sometimes result in a exothermic phenomenon.

For suppressing the reaction, the electrolyte and the electrode may be out of contact but this hinders the operation as the battery.

Further, while organic solvents and solutes showing stable characteristics also at a high temperature have been developed positively also for the non-aqueous electrolyte, the performance is lowered under a high temperature circumstance of 60° C. or higher and it can not be said that the high temperature characteristics are improved sufficiently.

For the non-aqueous electrolyte secondary battery, while various other methods have also been proposed for improving the high temperature characteristics, any of them provides less effect, and the reliability at a high temperature is insufficient.

In view of the above, the present invention is proposed for the situations described above and it intends to provide a non-aqueous lithium secondary battery maintaining high capacity even when stored under a high temperature circumstance or put to repetitive charge and discharge, and an electrode for use in the non-aqueous lithium secondary battery.

### SUMMARY OF THE INVENTION

The present inventor has made earnest studies for solving the foregoing problems and found that a lithium secondary battery capable of suppressing chemical reaction between a non-aqueous electrolyte and an electrode active material even under a high temperature circumstance, suppressing the lowering of the performance of the non-aqueous electrolyte and having a high reliability also under a high temperature circumstance by incorporating a predetermined amount of lithium ion conductive inorganic solid electrolyte to one or both of a positive electrode and a negative electrode in a lithium secondary battery.

Specifically, preferred embodiments of the invention have the following constitutions.

### Embodiment 1

A lithium secondary battery having an electrode containing a lithium ion conductive inorganic solid electrolyte powder by less than 5 wt % to at least one of a positive electrode or a negative electrode and using an ion conductive non-aqueous electrolyte.

### Embodiment 2

A lithium secondary battery according to embodiment 1 containing a polymer that absorbs a non-aqueous electrolyte between the positive electrode and the negative electrode.

### Embodiment 3

A lithium secondary battery according to embodiment 1, having a separator situated between the positive electrode and the negative electrode.

### Embodiment 4

A lithium secondary battery according to any one of embodiments 1 to 3, wherein the inorganic solid electrolyte powder contains crystals of: Li_{l+x+y}(Al,Ga)ₓ(Ti,Ge)₂₋ₓSi_{y}P_{3-y}O₁₂ (in which 0≦x≦1, 0≦y≦1).

### Embodiment 5

A lithium secondary battery according to embodiment 3 or 4, wherein the crystals are those not containing vacancy or crystal grain boundaries that hinder the ion conduction.

### Embodiment 6

A lithium secondary battery according to any one of embodiments 1 to 5, wherein the inorganic solid electrolyte powder comprises lithium composite oxide glass ceramics.

### Embodiment 7

A lithium secondary battery according to any one of embodiments 1 to 6, wherein the average particle size of the inorganic solid electrolyte powder is 20 μm or less.

### Embodiment 8

An electrode for use in a lithium secondary battery using ion conductive non-aqueous electrolyte containing less than 5 wt % of a lithium ion conductive inorganic solid electrolyte powder.

### Embodiment 9

An electrode according to embodiment 8, wherein the inorganic solid electrolyte powder contains crystals of:

Li_{1+x+y}(Al,Ga)ₓ(Ti,Ge)₂₋ₓSi_{y}P_{3-y}O₁₂

(in which 0≦x≦1, 0≦y≦1).

### Embodiment 10

An electrode according to embodiment 8 or 9, wherein the crystals are those not containing vacancy or crystal grain boundaries that hinder the ion conduction.

### Embodiment 11

An electrode according to any one of embodiments 8 to 10, wherein the inorganic solid electrolyte powder comprises lithium composite oxide glass ceramics.

### Embodiment 12

An electrode according to any one of embodiments 8 to 11, wherein the average particle size of the inorganic solid electrolyte powder is 20 μm or less.

According to the invention, a lithium secondary battery capable of suppressing chemical reaction between a non-aqueous electrolyte and an electrode active material under a high temperature circumstance, having a high reliability even under a high temperature circumstance, and improved with charge discharge characteristics is obtained by adding a predetermined amount of lithium ion conductive inorganic solid electrolyte powder to the inside of an electrode.

This is based on the finding that the effect of suppressing the chemical reaction between the non-aqueous electrolyte and the electrode active material under a high temperature circumstance is obtained by the presence of the inorganic solid electrolyte powder at the periphery of the active material.

Further, since the inorganic solid electrolyte powder covers the active material, the inorganic solid electrolyte powder decreases the reaction area between the active material and the non-aqueous electrolyte to further increase the effect of suppressing the chemical reaction between the non-aqueous electrolyte and the electrode active material.

Further, by the addition of the predetermined amount of lithium ion conductive inorganic solid electrolyte powder to the inside of the electrode, since the inorganic solid electrolyte powder in the electrode partially contributes to the lithium ion conduction in the electrode, the amount of the non-aqueous electrolyte can be decreased to improve the safety of the non-aqueous electrolyte secondary battery.

### PREFERRED EMBODIMENTS OF THE INVENTION

In the electrode of the lithium secondary battery according to the invention, at least one of a positive electrode or a negative electrode contains less than 5 wt % of a lithium ion conductive inorganic solid electrolyte powder.

By incorporation of the lithium ion conductive inorganic solid electrolyte powder to the electrode, chemical reaction between the non-aqueous electrolyte and the electrode active material can be suppressed under a high temperature circumstance to suppress the deterioration of the performance of the lithium secondary battery.

However, in a case where the content of the lithium ion conductive inorganic solid electrolyte powder in the electrode increases excessively, since the amount of the active material in the electrode decrease relatively, this tends to lower the battery capacity. Further, the rate characteristic (discharge characteristic) also tends to lower. Accordingly, for easily obtaining a battery of high capacity, the upper limit for the content of the lithium ion conductive inorganic solid electrolyte powder based on the electrode mix containing the inorganic solid electrolyte powder, is preferably, less than 5 wt %, more preferably, 4 wt % or less and, most preferably, 3 wt % or less.

Specifically, in a case where the rate characteristic is excellent (high), charging/discharging at a large current is possible. That is, charging in a short time is possible and discharging at a large current is possible.

Further, for easily suppressing the chemical reaction between the non-aqueous electrolyte and the electrode active material under a high temperature circumstance, the lower limit for the content of the lithium ion conductive inorganic solid electrolyte powder, based on the electrode mix containing the inorganic solid electrolyte powder, is preferably 0.1 wt % or more, more preferably, 0.3 wt % or more and, most preferably, 0.5 wt % or more.

The constitution of the invention can provide an effect of suppressing the chemical reaction of the electrode active material to the ion conductive non-aqueous electrolyte having a lithium salt dissolved in an organic solvent under a high temperature circumstance.

For the non-aqueous electrolyte, known non-aqueous electrolytes can be used and, for example, those having a lithium salts dissolved in organic solvents can be used.

For the organic solvent, ester type, ether type, carbonate type, or ketone type solvent can be used.

For the lithium salt, LiPF₆, LiBF₄, LiClO₄, LiN(SO₂CF₃)₂, LiN(SO₂C₂F₅)₂, or LiC(SO₂CF₃)₃, etc. can be used.

In the present specification, the lithium secondary battery is a collective name for lithium ion secondary batteries having a micro porous separator between a positive electrode and a negative electrode and using a non-aqueous electrolyte having ion conductivity, and lithium polymer secondary battery containing a polymer that absorbs a non-aqueous electrolyte between a positive electrode and a negative electrode, and the effect of the invention can be obtained in all of such batteries.

The lithium ion conductive inorganic solid electrolyte powder has high ionic conductivity by containing lithium ion conductive crystals and can have a conductivity sufficient to contribute to the lithium ion transfer in the electrode.

Therefore, by incorporating an inorganic solid electrolyte powder containing lithium ion conductive crystals to the inside of the electrode, an effect that the solid electrolyte partially contributes to the ion transfer in the electrode, the amount of the electrolyte can be decreased easily, and the safety as the battery can be improved easily. Further, by incorporating the inorganic solid electrolyte powder containing lithium ion conductive crystals in the electrode, the effect of suppressing the reaction between the active material and the non-aqueous electrolyte can be obtained more easily. In view of the above, the lithium ion conductive inorganic solid electrolyte powder preferably contains lithium ion conductive crystals.

The lithium ion conductive crystals include, for example, Li₃N, LISICONs, La_{0.55}Li_{0.35}TiO₃ having a perovskite structure, LiTi₂P₃O₁₂ having a NASICON type structure, etc.

Among them, particularly preferred lithium ion conductive crystals are:

Li_{l+x+y}(Al, Ga)ₓ(Ti, Ge)₂₋ₓSi_{y}P_{3-y}O₁₂

(in which 0≦x≦1, 0≦y≦1), and the crystals have an advantage that the lithium ion conductivity is high, and they are chemically stable and easy to handle with. Further, the crystals can be precipitated as crystals in glass ceramics by heat treatment of glass of a specified composition.

The lithium ion conductive crystals are advantageous in view of ion conduction in a case where the crystals do not contain crystal grain boundaries that hinder the ion conduction. Particularly, since glass ceramics scarcely have vacancy or crystal grain boundaries that hinder ion conduction, they have high ion conductivity and are excellent in chemical stability and, accordingly, are more preferred.

Further, while materials other than the glass ceramics that scarcely have vacancy or grain boundaries that hinder the ion conduction include single crystals of the crystals described above, they are difficult to be produced and are expensive. Also in view of the easy production and the cost, lithium ion conductive glass ceramics are advantageous.

Accordingly, the lithium ion conductive inorganic solid electrolyte powder in the form of a powder of the glass ceramics is preferred since high ion conductivity is obtained easily and production is also easy. Further, the lithium ion conductive inorganic solid electrolyte powder is, more preferably, lithium composite oxide glass ceramics in that the chemical stability is further higher. Particularly, a powder of glass ceramics in which the crystals:

Li_{1+x+y}(Al, Ga)ₓ(Ti, Ge)₂₋ₓSi_{y}P_{3-y}O₁₂

(in which 0≦x≦1, 0≦y≦1), are precipitated as a crystal phase is most preferred in view of high ion conductivity and chemical stability.

In a case of incorporating the powder of the glass ceramics in the electrode, the effect of suppressing the chemical reduction between the non-aqueous electrolyte and the electrode active material under a high temperature circumstance is increased by defining the content of the lithium ion conductive inorganic solid electrolyte powder in the electrode within the range of the content described above.

In the glass ceramics in which the crystals:

Li_{l+x+y}(Al, Ga)ₓ(Ti, Ge)₂₋ₓSi_{y}P_{3-y}O₁₂

(in which 0≦x≦1, 0≦y≦1) are precipitated as the crystal phase, crystals of:

Li_{l+x+y}(Al, Ga)ₓ(Ti, Ge)₂₋ₓSi_{y}P_{3-y}O₁₂

(in which 0≦x≦0.4, 0≦y≦0.6) are precipitated as the crystal phase can provide a high lithium ion conductivity of about 1×10⁻³ S/cm.

Further, in the glass ceramics in which the crystals:

Li_{l+x+y}(Al, Ga)ₓ(Ti, Ge)₂₋ₓSi_{y}P_{3-y}O₁₂

(in which 0≦x≦1, 0≦y≦1) are precipitated as a crystal phase, particularly, in a case of y=0, that is, in a case of glass ceramics in which crystals:

Li₁₊ₓ(Al, Ga)ₓ(Ti, Ge)₂₋ₓP₃O₁₂

(in which 0<x≦0.8) are precipitated as a crystal phase, while the lithium ion conductivity is at about 1×10⁻⁴ S/cm, since a mother glass before precipitation of the crystals can be cast into a dye, the degree of freedom in molding is relatively high and they can be molded into a relatively large bulk and, as a result, the production tends to be facilitated.

The glass ceramics are materials obtained by precipitating a crystal phase in a glass phase by subjecting the glass to a heat treatment, which are materials comprising amorphous solids and crystals and, further include materials in which the glass phase is entirely phase-transferred to a crystal phase, that is, those having the amount of crystals (degree of crystallization) in the material of 100 mass %. Even in the material crystallized to 100%, glass ceramics scarcely have vacancy between grains of crystals and in the crystals. On the contrary, in the so-called ceramics or the sintered products, presence of vacancy or crystal grain boundaries between the grains of the crystals and in the crystals is inevitable and can be distinguished from the glass ceramics of the invention. Particularly with respect to ion conduction, it has much lower value of the conductivity than that of the crystal grains per se due to the presence of the vacancy or crystal grain boundaries in the case of the ceramics. The glass ceramics can suppress the lowering of the conductivity between the grains by the control for the crystallizing step and conductivity about identical with the conductivity possessed essentially in the crystal particles per se can be obtained easily.

The glass ceramics in which the crystals:

Li_{1+x+y}(Al, Ga)ₓ(Ti, Ge)₂₋ₓSi_{y}P_{3-y}O₁₂

(in which 0≦x≦1, 0≦y≦1) are precipitated as a crystal phase can be obtained by melting and quenching the glass containing each of the ingredients, on the basis of mol %,
Li₂O: 10-25% and
Al₂O₃+Ga₂O₃: 0.5-15% and
TiO₂+GeO₂: 25-50% and
SiO₂:0-15% and
P₂O₃: 26-40%
   thereby obtaining a glass and then applying a heat treatment to the glass to precipitate crystals.

A preferred embodiment of the composition described above is to be described specifically for the compositional composition of each of the ingredients represented by mol % and the effects thereof.

The Li₂O ingredient is useful for providing Li⁺ ion carriers and providing lithium ion conductivity. For obtaining preferred ion conductivity more easily, the lower limit for the content is, preferably, 10%, more preferably, 13% and, most preferably, 14%. Further, in a case where the Li₂O ingredients is excessive, thermal stability of the glass tends to be worsened and the conductivity of the glass ceramics also tends to be lowered, so that the upper limit of the content is, preferably, 25%, more preferably, 17% and, most preferably, 16%.

The Al₂O₃ ingredients has an effect capable of improving the thermal stability of the mother glass and, at the same time, also improving the lithium ion conductivity since Al³⁺ ions are solid-solubilized to the crystal phase. For obtaining the effect more easily, the lower limit for the content is, preferably, 0.5% and, more preferably, 5.5% and, most preferably, 6%.

However, in a case where the content exceeds 15%, since the thermal stability of the glass is rather worsened tending to also lower the conductivity of the glass ceramics, the upper limit for the content is preferably 15%. Further, the upper limit for the more preferred content is 9.5% and the upper limit for the most preferred content is 9% for obtaining the effect more easily.

The TiO₂ ingredient contributes to the formation of the glass and is also a constituent ingredient for the crystal phase, which is an ingredient useful both in the glass and the crystals. For vitrification, and for obtaining a high ion conductivity more easily due to the precipitation of the crystal phase described above as a main phase from the glass, the lower limit for the content is, preferably, 25%, more preferably, 36% and, most preferably, 37%. Further, in a case where the TiO₂ ingredient is excessive, since the thermal stability of the glass tends to be worsened and also the conductivity of the glass ceramics also tends to be lowered, the upper limit for the content is preferably 50%, more preferably, 43% and, most preferably, 42%.

The SiO₂ ingredient can improve the melting property and the thermal stability of the mother glass and, at the same time, Si⁴⁺ ions are solid-solubilized in the crystal phase and contribute also to the improvement of the lithium ion conductivity. For obtaining the effect more sufficiently, the lower limit for the content is, preferably, 1%, more preferably, 2% and, most preferably, 3%. However, in a case where the content exceeds 10%, since the conductivity rather tends to be lowered, the upper limit for the content is preferably, 15%, more preferably, 8% and, most preferably, 7%.

Further, in a case of precipitating the crystals:

Li₁₊ₓ(Al, Ga)ₓ(Ti, Ge)₂₋ₓP₃O₁₂

(in which 0<x≦0.8), they do not contain sometimes the SiO₂ ingredient (SiO₂ ingredient: 0%).

The P₂O₅ ingredient is an ingredient useful for the formation of the glass and is also a constituent ingredient for the crystal phase. In a case where the content is less than 26%, since it is less vitrified, the lower limit for the content is, preferably, 26%, more preferably, 32% and, most preferably, 33%. In a case where the content exceeds 40%, since the crystal phase is less precipitated from the glass and the desired characteristic is less obtained, the upper limit for the content is, preferably, 40%, more preferably, 39% and, most preferably, 38%.

In the case of the composition described above, the glass can be obtained easily by casting a molten glass, and glass ceramics having the crystal phase obtained by a heat treatment of the glass have a high lithium ion conductivity of 1×10⁻⁴ S/cm to 1×10⁻³ S/cm.

Further, in addition to the composition described above, Al₂O₃ may be substituted by Ga₂O₃ and TiO₂ may be substituted by GeO₂ partially or entirely. Further, for lowering the melting point or improving the glass stability, other raw materials may also be added by a trace amount within a range not greatly deteriorating the ion conductivity.

Further, in a case of precipitating crystals of:

Li_{1+x+y}(Al, Ga)ₓTi₂₋ₓSi_{y}P_{3-y}O₁₂

(in which 0≦x≦0.4, 0<y≦0.6), they do not sometimes contain the GeO₂ ingredient (GeO₂ ingredient: 0%).

It is preferred that the composition described above does not contain alkali metals such as Na₂O or K₂0 other than Li₂O as much as possible. In a case where such ingredients are present in the glass ceramics, they tend to hinder the conduction of the lithium ions and lower the conductivity due to the mixing effect of the alkali ions.

Further, in a case of adding sulfur to the composition of the glass ceramics, while the lithium ion conductivity is improved somewhat, since the chemical durability or stability is worsened, it is preferred that sulfur is not contained as much as possible. It is preferred that the composition of the glass ceramics do not contain those ingredients such as Pb, As, Cd, and Hg which may possibly give undesired effects on the environments or human bodies as much as possible.

The upper limit for the average particle size of the lithium ion conductive inorganic solid electrolyte powder is preferably 20 μm or less, more preferably, 10 μm or less and, most preferably, 5 μm or less while considering the particle size of the active material in the electrode and the thickness of the electrode and further facilitating the dispersibility of the powder in the electrode.

The lower limit for the average particle size of the lithium ion conductive inorganic solid electrolyte powder is preferably 50 nm or more and, more preferably, 100 nm or more, and, most preferably, 140 nm or more for facilitating preferred dispersion into the electrode and bondability between the electrode materials to each other.

The average particle size is a value of D50 (accumulated 50% diameter) as measured by a laser diffraction method and, specifically, a value measured by a particle size distribution measuring equipment LS100Q or sub-micron grain analyzer N5 manufactured by Beckman Coulter Co. can be used. The average particle size is a value represented on the volume basis.

As the active material usable for the positive electrode material of the lithium secondary battery according to the invention, transition metal compounds capable of occluding and releasing lithium can be used and, for example, oxides of transition metals containing at least one member selected from manganese, cobalt, nickel, vanadium, niobium, molybdenum, and titanium can be used.

The positive electrode of the lithium secondary battery according to the invention contains the active material described above, a conduction aid and a binder and, optionally, contains the lithium ion conductive inorganic solid electrolyte powder described above.

For the conduction aid, carbonaceous materials such as acetylene black and other known materials can be used.

As the binder, fluoro resins such as PVDF (polyvinylidene fluoride) and other known materials can be used.

In the positive electrode of the invention, the electrode mix means a mixture of an active material, a conduction aid, a binder, and a lithium ion conductive inorganic solid electrolyte powder.

As the active material used for the negative electrode material, it is preferred to use metal lithium, lithium-aluminum alloys, and lithium-indium alloys capable of occluding and releasing lithium, oxides of transition metals such as titanium and vanadium, and carbonaceous materials such as graphite.

The negative electrode of the lithium secondary battery according to the invention contains the active material described above and the binder and, optionally contains the conduction aid, the lithium ion conductive inorganic solid electrolyte powder, or a polymeric solid electrolyte absorbing the ion conductive non-aqueous electrolyte.

As the binder, fluoro resins such as PVDF and other known materials can be used.

In the negative electrode of the invention, the electrode mix means a mixture of the active material, the conduction aid, the binder, and the lithium ion conductive inorganic solid electrolyte powder.

The lithium secondary battery according to the invention can be obtained by incorporating the lithium ion conductive inorganic solid electrolyte powder to at least one of a positive electrode and a negative electrode, interposing a micro porous film comprising polypropylene or the like as a separator between the positive electrode and the negative electrode, disposing a current collector to each of the positive electrode and the negative electrode, containing them in a casing, and pouring the non-aqueous electrolyte.

Further, the lithium secondary battery can also be obtained by interposing a polymeric solid electrolyte absorbing a non-aqueous electrolyte such as a lithium ion conductive gel polymer or polymeric solid electrolyte instead of the micro porous film separator between the positive electrode and the negative electrode, disposing a current collector to each of the positive electrode and the negative electrode, containing them in a casing and them pouring the non-aqueous electrolyte.

### EXAMPLE

A lithium ion lithium secondary battery and an electrode for use in the lithium secondary battery according to the invention are to be described with reference to specific examples. The invention is not restricted to the examples to be described below but can be practiced with an appropriate modification within a range not departing the gist thereof.

### [Preparation of Lithium Ion Conductive Inorganic Solid Electrolyte Powder]

H₃PO₄, Al(PO₃)₃, Li₂CO₃, SiO₂, and TiO₂ were used as the raw materials, they were weighed so as to obtain a composition of 35.0% of P₂O₅, 7.5% of Al₂O₃, 15.0% of Li₂O, 38.0% of TiO₂, and 4.5% of SiO₂ by mol % on the oxide basis and mixed uniformly, then they were placed in a platinum pot and melted by heating at 1500° C. for 4 hours in an electric furnace while stirring a molten glass liquid. Then, a flaky glass was obtained by dropping the molten glass liquid into running water and the glass was crystallized by a heat treatment at 950° C. for 12 hours to obtain aimed glass ceramics. It was confirmed that the precipitated crystal phase had a main crystal phase of:

Li_{1+x+y}AlₓTi₂₋ₓSi_{y}P_{3-y}O₁₂

(in which 0≦x≦0.4, 0<y≦6) by powder X-ray diffractiometry. This is defined as glass ceramics A. Further, the ion conductivity of the glass ceramics A was about 1×10⁻³ S/cm.

Then, H₃PO₄, Al(PO₃)₃, Li₂CO₃, ZrO₂, TiO₂, and GeO₂ were used as the raw materials, they were weighed so as to obtain a composition of 40.0% P₂O₅, 8.0% of Al₂O₃, 15.0% of Li₂O, 1.0% of ZrO₂, 17.0% of TiO₂, and 20.0% of GeO₂ by mol % on the oxide basis and mixed uniformly. Then they were placed in a platinum pot and melted by heating at 1500° C. for 4 hours in an electric furnace while stirring a molten glass liquid. Then, a flaky glass was obtained by dropping the molten glass liquid into running water and the glass was crystallized by a heat treatment at 950° C. for 12 hours to obtain aimed glass ceramics. It was confirmed that precipitated crystal phase had a main crystal phase of:

Li_{l+x(Al, Ga)}ₓ(Ti, Ge)₂₋ₓP₃O₁₂

(in which 0<x≦0.8) by powder X-ray diffractiometry. This is defined as glass ceramics B. Further, the ion conductivity of the glass ceramics B was about 1×10⁻⁴ S/cm.

Flakes of the obtained glass ceramics A, B were pulverized respectively by a laboratory scale jet mill and classified by a rotational roller made of zirconia to obtain a powder of glass ceramics of an average particle size of 20 μm. The obtained powder was further pulverized by a planetary ball mill, attritor, beads mill, etc. to obtain glass ceramics powders having average particle sizes in each of the examples to be described later.

### Example 1

### 1) Preparation of Positive Electrode

87.5 wt % of LiCoO₂ as a positive electrode active material, 3 wt % of acetylene black as a conduction aid material, 5 wt % of PVDF as a binder, and 4.5 wt % of glass ceramics A (average particle size: 3 μm) were mixed, to which NMP (N-methyl pyrrolidone) was added and prepared into a paste form. The paste was coated on an Al foil current collector and dried at 100° C. Then, it was pressed to 100 μm thickness and cut into 50 mm square prepare positive electrodes. LiCoO₂ having an average particle size of 8 μm was used in this example.

### 2) Preparation of Negative Electrode

A Cu foil of 18 μm thickness was used as a negative electrode current collector. 92 wt % of graphite as an active material, and 8 wt % of PVDF as a binder were mixed, to which NMP was added and prepared to a paste form. The paste was coated uniformly on the negative electrode current collector and dried at 100° C. Then, it was pressed to 80 μm thickness and cut into 52 mm square to prepare negative electrodes. Graphite having an average particle size of 15 μm was used.

### 3) Preparation of Battery

The positive electrode and the negative electrode obtained in (1) and (2) above were laminated and wound by way of a micro porous polypropylene film of 25 μm thickness cut into 54 mm square to prepare an electrode assembly. It was contained in a metal laminated resin film case. Then, a non-aqueous electrolyte EC (ethylene carbonate):DEC (diethyl carbonate)=1:1 volume ratio and LiPF₆ (lithium hexafluoro phosphate):1 mol/L as the concentration of the non-aqueous electrolyte) was poured by 0.5 cc into the case and tightly sealed by welding to prepare a battery.

### Example 2

90 wt % of LiCoO₂ as a positive electrode active material, 3 wt % of acetylene black as a electron conduction additive, 5 wt % of PVDF as a binder, and 2 wt % of glass ceramics A (average particle size: 0.5 μm) were mixed, to which NMP was added and prepared into a paste form. The paste was coated on an Al foil current collector and dried at 100° C. Then, it was pressed to 100 μm thickness and cut into 50 mm square to prepare positive electrodes.

A battery was prepared in the same manner as in Example 1 by using a negative electrode prepared in the same manner in Example 1.

### Example 3

90.5 wt % of LiCoO₂ as a positive electrode active material, 3 wt % of acetylene black as a electron conduction additive, 5 wt % of PVDF as a binder, and 1.5 wt % of glass ceramics A (average particle size: 0.2 μm) were mixed, to which NMP was added and prepared into a paste form. The paste was coated on an Al foil current collector and dried at 100° C. Then, it was pressed to 100 μm thickness and cut into 50 mm square to prepare positive electrodes.

91.9 wt % of graphite as a negative electrode active material, 8 wt % of PVDF as a binder material, and 0.1 wt % of glass ceramics A (average particle size: 0.2 μm) were mixed, to which NMP was added and prepared into a paste form. The paste was uniformly coated on a negative electrode current collector and dried at 100° C. to prepare a negative electrode. Graphite having an average particle size of 15 μm was used.

A battery was prepared in the same manner as in Example 1 by using the thus prepared positive electrode and negative electrode.

### Example 4

88 wt % of LiCoO₂ as a positive electrode active material, 3 wt % of acetylene black as a electron conduction additive, 5 wt % of PVDF as a binder, and 4 wt % of glass ceramics B (average particle size: 2 μm) were mixed, to which NMP was added and prepared into a paste form. The paste was coated on an Al foil current collector and dried at 100° C. Then, it was pressed to 100 μm thickness and cut into 50 mm square to prepare positive electrodes.

A battery was prepared in the same manner as in Example 1 by using a negative electrode prepared in the same manner as in Example 1.

### Example 5

88 wt % of LiCoO₂ as a positive electrode active material, 3 wt % of acetylene black as a electron conduction additive, 5 wt % of PVDF as a binder, and 4 wt % of glass ceramics B (average particle size: 1 μm) were mixed, to which NMP was added and prepared into a paste form. The paste was coated on an Al foil current collector and dried at 100° C. Then, it was pressed to 100 μm thickness and cut into 50 mm square to prepare positive electrodes.

A battery was prepared in the same manner as in Example 1 by using a negative electrode prepared in the same manner as in Example 1.

### Example 6

88.5 wt % of LiCoO₂ as a positive electrode active material, 3 wt % of acetylene black as a electron conduction additive, 5 wt % of PVDF as a binder, and 3.5 wt % of glass ceramics B (average particle size: 0.15 μm) were mixed, to which NMP was added and prepared into a paste form. The paste was coated on an Al foil current collector and dried at 100° C. Then, it was pressed to 100 μm thickness and cut into 50 mm square to prepare positive electrodes.

91.5 wt % of graphite as a negative electrode active material, 8 wt % of PVDF as a binder material, and 0.5 wt % of glass ceramics B (average particle size: 0.15 μm) were mixed, to which NMP was added and prepared into a paste form. The paste was uniformly coated on a negative electrode current collector and dried at 100° C. to prepare a negative electrode. Graphite having an average particle size of 15 μm was used.

A battery was prepared in the same manner as in Example 1 by using the thus prepared positive electrode and the negative electrode.

### Example 7

89 wt % of LiCoO₂ as a positive electrode active material, 3 wt % of acetylene black as a electron conduction additive, 5 wt % of PVDF as a binder, and 3 wt % of La_{0.55}Li_{0.35}TiO₃ (average particle size: 0.5 μm) were mixed, to which NMP was added and prepared into a paste form. The paste was coated on an Al foil current collector and dried at 100° C. Then, it was pressed to 100 μm thickness and cut into 50 mm square to prepare positive electrodes.

A battery was prepared in the same manner as in Example 1 by using a negative electrode prepared in the same manner as in Example 1.

### Example 8

89.5 wt % of LiCoO₂ as a positive electrode active material, 3 wt % of acetylene black as a electron conduction additive, 5 wt % of PVDF as a binder, and 2.5 wt % of Li₂SiO₃ (average particle size: 0.5 μm) were mixed, to which NMP was added and prepared into a paste form. The paste was coated on an Al foil current collector and dried at 100° C. Then, it was pressed to 100 μm thickness and cut into 50 mm square to prepare positive electrodes.

A battery was prepared in the same manner as in Example 1 by using a negative electrode prepared in the same manner as in Example 1.

### Example 9

87.5 wt % of LiCoO₂ as a positive electrode active material, 3 wt % of acetylene black as a electron conduction additive, 5 wt % of PVDF as a binder, and 4.5 wt % of glass ceramics A (average particle size: 1 μm) were mixed, to which NMP was added and prepared into a paste form. The paste was coated on an Al foil current collector and dried at 100° C. Then, it was pressed to 100 μm and cut into 50 mm square prepare positive electrodes.

The negative electrode was prepared in the same manner as in Example 1. A non-aqueous electrolyte (EC:DEC=50:50 vol %, LiPF₆: 1 mol/L as the concentration of non-aqueous electrolyte) was immersed into the prepared electrode. Further, as a polymeric electrolyte, a non-aqueous electrolyte (EC:DEC=1:1 volume ratio, LiPF₆: 1 mol/L as the concentration of the non-aqueous electrolyte) was immersed into a micro porous PVDF film of 20 μm thickness cut into 54 mm square to prepare a gel-like electrolyte. The obtained positive electrode and negative electrode were laminated by way of the gel-like electrolyte to prepare an electrode assembly. The electrode assembly was contained in a metal laminated resin film case and tightly sealed by welding to prepare a battery.

### Example 10

89.5 wt % of LiCoO₂ as a positive electrode active material, 3 wt % of acetylene black as a electron conduction additive, 5 wt % of PVDF as a binder, and 2.8 wt % of glass ceramics B (average particle size: 1 μm) were mixed, to which NMP was added and prepared into a paste form. The paste was coated on an Al foil current collector and dried at 100° C. Then, it was pressed to 100 μm and cut into 50 mm square to prepare positive electrodes.

The negative electrode was prepared in the same manner as in Example 1. A non-aqueous electrolyte (EC:DEC=1:1 volume ratio, LiPF₆: 1 mol/L as the concentration of non-aqueous electrolyte) was immersed into the prepared electrode. Further, as a polymeric electrolyte, a non-aqueous electrolyte (EC:DEC=1:1 volume ratio, LiPF₆: 1 M) was immersed into a micro porous PVDF film of 20 μm thickness cut into 54 mm square to prepare a gel-like electrolyte. The obtained positive electrode and negative electrode were laminated by way of the gel-like electrolyte to prepare an electrode assembly. The electrode assembly was contained in a metal laminated resin film case and tightly sealed by welding to prepare a battery.

### Comparative Example 1

### 1) Preparation of Positive Electrode

As a positive electrode current collector, an Al foil of 20 μm thickness was used. 90 wt % of LiCoO₂ as a positive electrode active material, 3 wt % of acetylene black as a electron conduction additive and 7 wt % of PVDF as a binder material were mixed, to which NMP was added to prepare into a paste form. The paste was uniformly coated on a positive electrode current collector and dried at 100° C. Then, it was pressed to 100 μm thickness and cut into 50 mm square to prepare a positive electrode.

### 2) Preparation of Negative Electrode

As a negative electrode current collector, an Cu foil of 18 μm thickness was used. 92 wt % of graphite as an active material, and 8 wt % of PVDF as a binder material were mixed, to which NMP was added to prepare into a paste form. The paste was uniformly coated on a negative electrode current collector and dried at 100° C. Then, it was pressed to 80 μm thickness and cut into 52 mm square to prepare a negative electrode. Graphite having an average particle size of 15 μm was used.

### 3) Preparation of Battery

The positive electrode and the negative electrode obtained in (1) and (2) above were laminated by way of a micro porous polypropylene film of 25 μm thickness cut into 54 mm square to prepare an electrode assembly. It was contained in a metal laminated resin film case. Then, a non-aqueous electrolyte (EC:DEC=1:1 and LiPF₆: 1 mol/L as the concentration of non-aqueous electrolyte) was poured by 0.5 cc into the case and tightly sealed by welding to prepare a battery.

The batteries prepared as described above were completely charged at a room temperature up to 4.2 V by constant current—constant voltage charging and then discharged to a discharge cut-off voltage of 2.7 V at a current value of 1/5 C. Then, identical charge/discharge cycles were repeated under a high circumstantial atmosphere at 60° C. and the result of determining the capacity maintaining ratio at 100th cycle relative to the second cycle is shown in Table 1.

TABLE 1

| | | | Solid | |
|---|---|---|---|---|
| | | Solid electrolyte | electrolyte | |
| | | content in | content in | Capacity |
| | | positive | negative | maintaining |
| | Separator | electrode (%) | electrode (%) | ratio (%) |
| Example 1 | Micro porous PP film | 4.5 | 0 | 89 |
| Example 2 | Micro porous PP film | 2 | 0 | 91 |
| Example 3 | Micro porous PP film | 1.5 | 0.1 | 93 |
| Example 4 | Micro porous PP film | 4 | 0 | 85 |
| Example 5 | Micro porous PP film | 3.5 | 0 | 82 |
| Example 6 | Micro porous PP film | 1.5 | 0.5 | 88 |
| Example 7 | Micro porous PP film | 3 | 0 | 83 |
| Example 8 | Micro porous PP film | 2.5 | 0 | 79 |
| Example 9 | Polymer electrolyte | 4.5 | 0 | 86 |
| Example 10 | Polymer electrolyte | 2.5 | 0 | 87 |
| Comp. | Micro porous PP film | 0 | 0 | 58 |
| Example 1 | | | | |

Then, batteries of Examples 1 to 8 and Comparative Example 1 were completely charged to 4.2 V. Then, a peg of 2.5 mm diameter was penetrated through each of them to forcively cause internal short-circuit.

As a result, in the existent battery of Comparative Example 1, the battery surface temperature reached 300° C. or higher and white smoke was observed. However, in Examples 1 to 10 of the invention, no white smoke was generated and the surface of the battery was kept at a relatively low temperature of 120° C. or lower. That is, it was found that the non-aqueous electrolyte battery having the electrode containing the inorganic solvent electrolyte was improved more for the safety compared with the existent battery.

What is claimed is:

1. A lithium secondary battery having an electrode in which at least one of a positive electrode or a negative electrode contains less than 5 wt % of a lithium ion conductive inorganic solid electrolyte powder using a non-aqueous electrolyte having an ion conductivity.

2. A lithium secondary battery according to claim 1 having a polymer that absorbs the non-aqueous electrolyte between the positive electrode and the negative electrode.

3. A lithium secondary battery according to claim 1 having a separator situated between the positive electrode and the negative electrode.

4. A lithium secondary battery according to claim 1, wherein the inorganic solid electrolyte powder contains crystals of:
Li_{l+x+y}(Al, Ga)ₓ(Ti, Ge)₂₋ₓSi_{y}P_{3-y}O₁₂
(in which 0≦x≦1, 0≦y≦1).

5. A lithium secondary battery according to claim 4, wherein the crystals are those not containing vacancy or crystal grain boundaries that hinder the ion conduction.

6. A lithium secondary battery according to claim 5, wherein the inorganic solid electrolyte powder comprises lithium composite oxide glass ceramics.

7. A lithium secondary battery according to claim 1, wherein the average particle size of the inorganic solid electrolyte powder is 20 μm or less.

8. An electrode for use in a lithium secondary battery using an ion conducting non-aqueous electrolyte containing less than 5 wt % of a lithium ion conductive inorganic solid electrolyte powder.

9. An electrode according to claim 8, wherein the inorganic solid electrolyte powder contains crystals of:
Li_{1+x+y}(Al, Ga)ₓ(Ti, Ge)₂₋ₓSi_{y}P_{3-y}O₁₂
(in which 0≦x≦1, 0≦y≦1).

10. An electrode according to claim 9, wherein the crystals are those not containing vacancy or crystal grain boundaries that hinder the ion conduction.

11. An electrode according to claim 10, wherein the inorganic solid electrolyte powder comprises lithium composite oxide glass ceramics.

12. An electrode according to claim 8, wherein the average particle size of the inorganic solid electrolyte powder is 20 μm or less.
